(19) United States
(12) Patent Application Publication
(10) Pub. No.: US 2017/0204644 A1
(43) Pub. Date: Jul. 20, 2017

(54) Combination Door Assembly

(71) Applicants: Robert Mc Mullen, JR., Huston, TX (US); Christian Lauer, Bonnie Lake, WA (US)

(72) Inventors: Robert Mc Mullen, JR., Huston, TX (US); Christian Lauer, Bonnie Lake, WA (US)

(21) Appl. No.: 14/997,645

(22) Filed: Jan. 18, 2016

(51) Int. Cl. E05D 15/58; E05D 15/06; E05C 7/00; E06B 3/92

(52) U.S. Cl. CPC E05D 15/58; E06B 3/92; E05D 15/0678; E05C 7/00; E05Y 2900/132; E05D 2015/585; E05D 2015/485

(57) ABSTRACT

A combination door assembly includes a frame that may be coupled to a wall of a building. A door is hingedly coupled to the frame such that the door is positionable between an open position and a closed position. The door comprises a first half that is slidably coupled to a second half. The second half is positionable in an open position when the door is positioned in the closed position. Thus, the second half is configured to allow egress and entry to the building when the door is in the closed position.

### BACKGROUND OF THE DISCLOSURE

### Field of the Disclosure

The disclosure relates to door devices and more particularly pertains to a new door device for combining elements of a hinged door and a sliding door.

### SUMMARY OF THE DISCLOSURE

An embodiment of the disclosure meets the needs presented above by generally comprising a frame that may be coupled to a wall of a building. A door is hingedly coupled to the frame such that the door is positionable between an open position and a closed position. The door comprises a first half that is slidably coupled to a second half. The second half is positionable in an open position when the door is positioned in the closed position. Thus, the second half is configured to allow egress and entry to the building when the door is in the closed position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a combination door assembly according to an embodiment of the disclosure.

FIG. 2 is a front view of an embodiment of the disclosure.

FIG. 3 is a top cut away view of an embodiment of the disclosure.

FIG. 4 is a detail view of an embodiment of the disclosure.

FIG. 5 is a cross sectional view taken along line 5-5 of FIG. 2 of an embodiment of the disclosure.

FIG. 6 is a cross sectional view taken along line 6-6 of FIG. 2 of an embodiment of the disclosure.

FIG. 7 is a perspective in-use view of an embodiment of the disclosure.

### DESCRIPTION OF THE PREFERRED EMBODIMENT

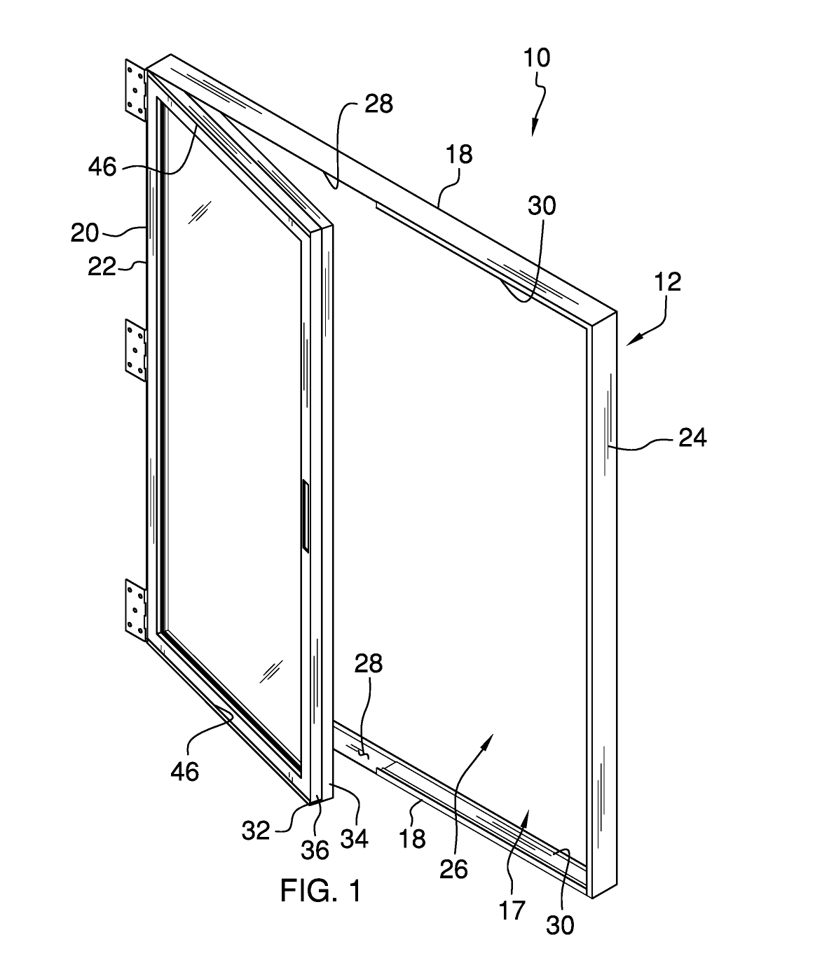

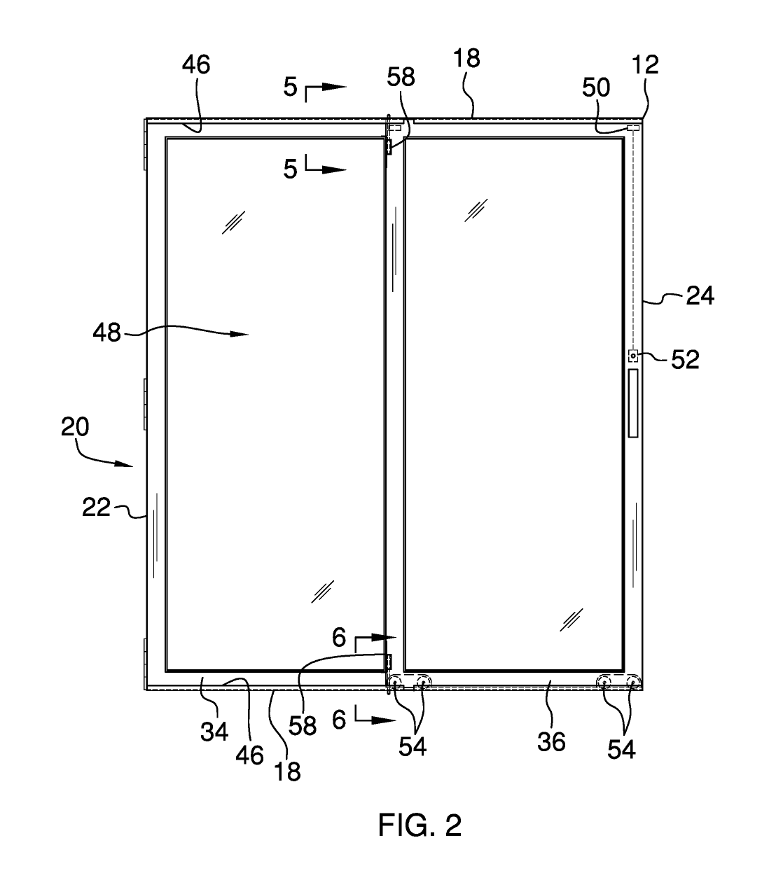

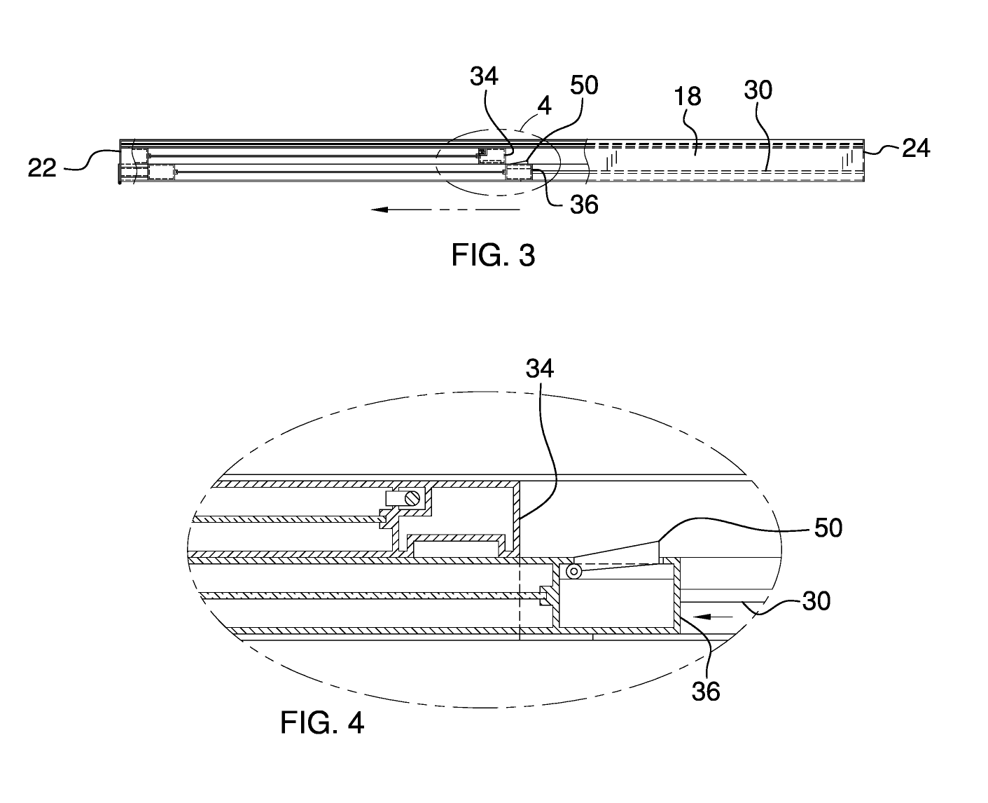

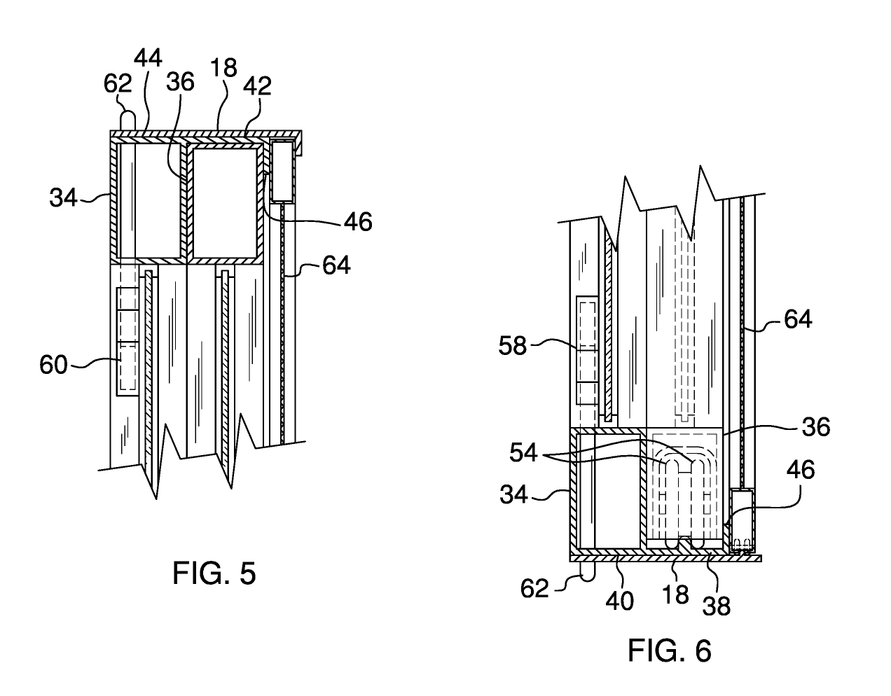

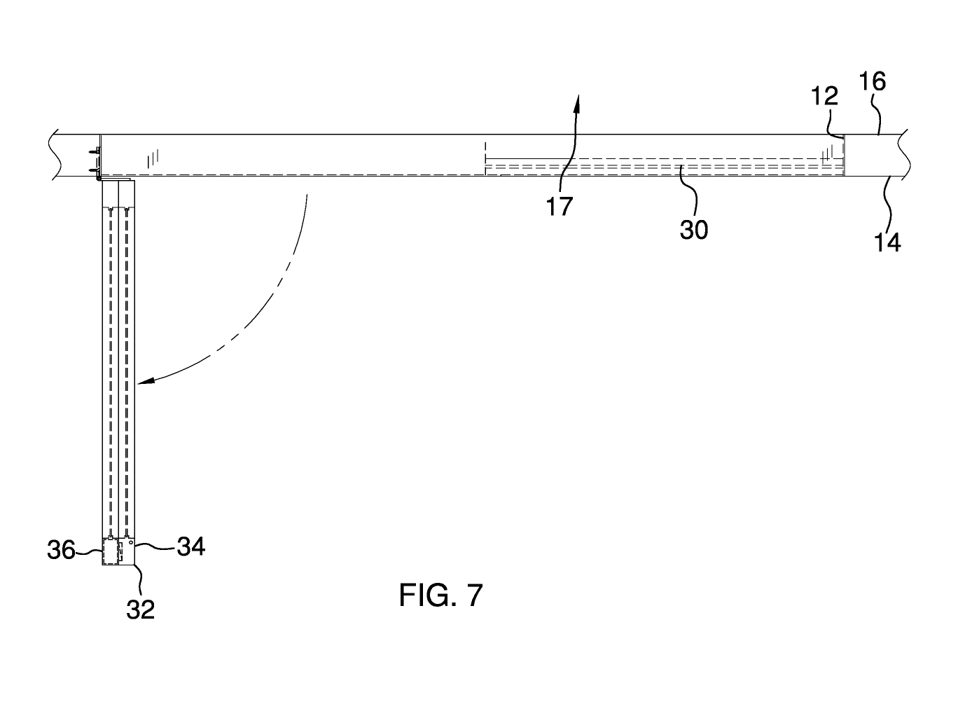

With reference now to the drawings, and in particular to FIGS. 1 through 7 thereof, a new door device embodying the principles and concepts of an embodiment of the disclosure and generally designated by the reference numeral 10 will be described.

As best illustrated in FIGS. 1 through 7, the combination door assembly 10 generally comprises a frame 12 that may be coupled to a wall 14 of a building 16 such that the frame defines an entry 17 in the building 16. The building 16 may comprise a house or the like. The frame 12 has a pair of lateral arms 18 that each extend between a pair of longitudinal arms 20. The pair of longitudinal arms 20 includes a first longitudinal arm 22 and a second longitudinal arm 24. The first longitudinal arm 22 is spaced from the second longitudinal arm 24 such that the frame 12 defines an opening 26. Each of the lateral arms 18 has an inwardly facing surface 28 with respect to the opening 26.

A pair of tracks 30 is provided. Each of the tracks 30 is coupled to an associated one of the lateral arms 18. Each of the tracks 30 extends from the first longitudinal arm 22 to a point positioned between the first longitudinal arm 22 and the second longitudinal arm 24. Each of the tracks 30 is positioned on the inwardly facing surface 28 of the associated lateral arm 18.

A door 32 is hingedly coupled to the frame 12 and the door 32 is positionable between an open position and a closed position. The door 32 comprises a first half 34 and a second half 36. The second half 36 is slidably coupled to the first half 34. The second half 36 is positionable in an open position when the door 32 is positioned in the closed position. Thus, the second half 36 facilitates egress and entry to the building 16 when the door 32 is in the closed position. Each of the first half 34 and the second half 36 may comprise a glass door or the like.

The first half 34 is hingedly coupled to the second longitudinal arm 24 such that the first half 34 extends between the lateral arms 18. The first half 34 has a first lip 38 extending away from a bottom side 40 of the first half 34. The first lip 38 is coextensive with the bottom side 40. The first half 34 has a second lip 42 extending outwardly from a top side 44 of the first half 34. The second lip 42 is coextensive with the top side 44. Each of the first lip 38 and the second lip 42 has a ledge 46 extending toward a center 48 of the first half 34. The ledge 46 corresponding to each of the first lip 38 and the second lip 42 is spaced from the first half 34.

The second half 36 is slidably positioned on each of the first lip 38 and the second lip 42. The second half 36 is positioned between the first half 34 and the ledge 46 corresponding to each of the first lip 38 and the second lip 42. Thus, the first half 34 is slidably retained on the second half 36. Each of the first lip 38 and the second lip 42 is aligned with an associated one of the tracks 30 when the door 32 is positioned in the closed position. The second half 36 is slidable along each of the tracks 30 to abut the first longitudinal arm 22 when the second half 36 is positioned in a closed position. Thus, the opening 26 is completely closed.

A latch 50 is movably coupled to the second half 36. The latch 50 engages the first half 34 when the second half 36 is positioned in the open position. Thus, the second half 36 is coupled to the first half 34. An actuator 52 is movably coupled to the second half 36 and the actuator 52 may be manipulated. The actuator 52 is in mechanical communication with the latch 50. The latch 50 is urged to disengage from the first half 34 when the actuator 52 is manipulated. Thus, the second half 36 may be positioned in the open position.

A plurality of rollers 54 is provided. Each of the rollers 54 is rollably coupled to a bottom side 56 of the second half 36. The rollers 54 are spaced apart from each other and are distributed along the bottom side 56 corresponding to the second half 36. Each of the rollers 54 rolls along an associated one of the tracks 30 and the first lip 38 when the second half 36 is positioned between the closed position and the open position.

A pair of locks 58 is provided. Each of the locks 58 is movably coupled to the first half 34 and each of the locks 58 may be manipulated. Each of the locks 58 is positionable between a locking position and a releasing position. Each of the locks 58 may engage an associated one of the lateral arms 18 of the frame 12 when the locks 58 are positioned in the locking position. Thus, the door 32 is retained in the closed position.

Each of the locks 58 disengages the associated lateral arms 18 when the locks 58 are positioned in the releasing position. Thus, the door 32 is positionable in the open position. Each of the locks 58 may comprise a lever 60 that is mechanically coupled to a rod 62. The rod 62 may extend outwardly from the first half 32 when the lever 60 is manipulated into a locking position. The rod 62 corresponding to each of the locks 60 may engage the associated lateral arm 18. The rod 62 may retract into the first half 34 when the lever 60 is manipulated into a releasing position.

A screen door 64 may be provided. The screen door 64 may be positionable to extend between each of the tracks 30. The screen door 64 may cover the exposed opening 26 when the first half 34 is positioned in the open position. The screen door 64 may be an exterior screen door or the like.

In use, the door 32 is positioned in the closed position to completely close the opening 26. The first half 34 is positioned in the open position when the door 32 is positioned in the closed position. Thus, the opening 26 is partially exposed. The door 32 is positioned in the open position when the first half 34 is in the open position. Thus, the opening 26 is fully exposed. Each of the locks 58 is positioned in the locking position when the door 32 is in the closed position. Thus, the door 32 is retained in the closed position. The actuator 52 is manipulated to facilitate the first half 34 to be positioned in the closed position.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A combination door assembly comprising:
a frame being configured to be coupled to a wall of a building such that said frame defines an entry in the building, said frame including a first longitudinal arm, a second longitudinal arm and a pair of lateral arms; and
a door being hingedly coupled to said frame such that said door is positionable between an open position and a closed position, said door comprising a first half and a second half, said second half being slidably coupled to said first half, said second half being positionable in an open position when said door is positioned in said closed position wherein said second half is configured to allow egress and entry to the building when said door is in said closed position, said first half being hingedly coupled to said first longitudinal arm such that said first half extends between said lateral arms;
a first lip extending away from a bottom side of said first half, said first lip being coextensive with said bottom side; and
a second lip extending outwardly from a top side of said first half, said second lip being coextensive with said top side, each of said first lip and said second lip having a ledge extending toward a center of said first half, said ledge corresponding to each of said first lip and said second lip being spaced from said first half; and
said second half being slidably positioned on each of said first lip and said second lip, said second half having a bottom side being positioned directly between said first half and said ledge corresponding to said first lip, said second half having an upper side being positioned directly between said first half and said ledge corresponding to said second lip such that said second half is slidably retained on said first half.

2. The assembly according to claim 1, further comprising said first longitudinal arm being spaced from said second longitudinal arm such that said frame defines an opening, each of said lateral arms having an inwardly facing surface with respect to said opening.

3. The assembly according to claim 2, further comprising a pair of tracks, each of said tracks being coupled to an associated one of said lateral arms, each of said tracks extending from said second longitudinal arm to a point being positioned between said first longitudinal arm and said second longitudinal arm, each of said tracks being positioned on said inwardly facing surface of said associated lateral arm.

4. (canceled)

5. (canceled)

6. (canceled)

7. The assembly according to claim 1, wherein each of said first lip and said second lip is aligned with an associated one of said tracks when said door is positioned in said closed position, said second half being slidable along each of said tracks and abutting said second longitudinal arm when said second half is positioned in a closed position.

8. The assembly according to claim 1, further comprising:
a latch being movably coupled to said second half, said latch engaging said first half when said second half is positioned in said open position such that said second half is coupled to said first half; and
an actuator being movably coupled to said second half wherein said actuator is configured to be manipulated, said actuator being in mechanical communication with said latch, said latch being urged to disengage from said first half when said actuator is manipulated.

9. The assembly according to claim 3, further comprising a plurality of rollers, each of said rollers being rollably coupled to said second half and extending from said bottom side of said second half, said rollers being spaced apart from each other and being distributed along said bottom side corresponding to said second half, each of said rollers rolling along an associated one of said tracks when said second half is positioned in said closed position.

10. The assembly according to claim 2, further comprising a pair of locks, each of said locks being movably coupled to said first half wherein each of said locks is configured to be manipulated, each of said locks being positionable between a locking position and a releasing position, each of said locks engaging an associated one of said lateral arms of said frame when said locks are positioned in said locking position such that said door is retained in said closed position, each of said locks disengaging said associated lateral arms when said lock are positioned in said releasing position such that said door is positionable in said open position.

11. A combination door assembly comprising:
a frame being configured to be coupled to a wall of a building such that said frame defines an entry in the building, said frame having a pair of lateral arms each extending between a pair of longitudinal arms, said pair of longitudinal arms including a first longitudinal arm and a second longitudinal arm, said first longitudinal arm being spaced from said second longitudinal arm such that said frame defines an opening, each of said lateral arms having an inwardly facing surface with respect to said opening;
a pair of tracks, each of said tracks being coupled to an associated one of said lateral arms, each of said tracks extending from said first longitudinal arm to a point being positioned between said first longitudinal arm and said second longitudinal arm, each of said tracks being positioned on said inwardly facing surface of said associated lateral arm;
a door being hingedly coupled to said frame such that said door is positionable between an open position and a closed position, said door comprising a first half being slidably coupled to a second half, said second half being positionable in an open position when said door is positioned in said closed position wherein said second half is configured to allow egress and entry to the building when said door is in said closed position, said first half being hingedly coupled to said second longitudinal arm such that said first half extends between said lateral arms;
a first lip extending away from a bottom side of said first half, said first lip being coextensive with said bottom side;
a second lip extending outwardly from a top side of said first half, said second lip being coextensive with said top side, each of said first lip and said second lip having a ledge extending toward a center of said first half, said ledge corresponding to each of said first lip and said second lip being spaced from said first half, said second half being slidably positioned on each of said first lip and said second lip, said second half having a bottom side being positioned directly between said first half and said ledge corresponding to said first lip, said second half having an upper side being positioned directly between said first half and said ledge corresponding to said second lip such that said second half is slidably retained on said first half, each of said first lip and said second lip being aligned with an associated one of said tracks when said door is positioned in said closed position, said second half being slidable along each of said tracks and abutting said first longitudinal arm when said second half is positioned in a closed position;
a latch being movably coupled to said second half, said latch engaging said first half when said second half is positioned in said open position such that said second half is coupled to said first half;
an actuator being movably coupled to said second half wherein said actuator is configured to be manipulated, said actuator being in mechanical communication with said latch, said latch being urged to disengage from said first half when said actuator is manipulated;
a plurality of rollers, each of said rollers being rollably coupled to said second half and extending from said bottom side of said second half, said rollers being spaced apart from each other and being distributed along said bottom side corresponding to said second half, each of said rollers rolling along an associated one of said tracks when said second half is positioned in said closed position; and
a pair of locks, each of said locks being movably coupled to said first half wherein each of said locks is configured to be manipulated, each of said locks being positionable between a locking position and a releasing position, each of said locks engaging an associated one of said lateral arms of said frame when said locks are positioned in said locking position such that said door is retained in said closed position, each of said locks disengaging said associated lateral arms when said lock are positioned in said releasing position such that said door is positionable in said open position.
